(19) United States
(12) Patent Application Publication
(10) Pub. No.: US 2024/0331293 A1
(43) Pub. Date: Oct. 3, 2024

(54) SYSTEM FOR AUTOMATED GENERATION OF FACIAL SHAPES FOR VIRTUAL CHARACTER MODELS

(71) Applicant: Electronic Arts Inc., Redwood City, CA (US)

(72) Inventors: Igor Borovikov, Foster City, CA (US); Karine Levonyan, Belmont, CA (US); Mihai Anghelescu, Coquitlam (CA); Dave Auclair, Winter Park, FL (US); Arjuna Ravikumar, Redwood City, CA (US); Harold Henry Chaput, Castro Valley, CA (US)

(21) Appl. No.: 18/194,074

(22) Filed: Mar. 31, 2023

(51) Int. Cl. G06T 17/20; G06V 10/82; G06V 40/16

(52) U.S. Cl. CPC G06T 17/20; G06V 10/82; G06V 40/168

(57) ABSTRACT

Systems and methods are provided for enhanced face shape generation for virtual entities based on generative modeling techniques. An example method includes training models based on synthetically generated faces and information associated with an authoring system. The modeling system being trained to reconstruct face shapes for virtual entities based on a latent space embedding of a face identity.

### TECHNICAL FIELD

The present disclosure relates to systems and techniques for generation of facial shapes for virtual character models. More specifically, this disclosure relates to machine learning techniques for character model generation of human faces.

### BACKGROUND

Electronic games are increasingly becoming more realistic due to an increase in available processing resources. Populating virtual worlds with many realistic-looking characters is far from trivial yet in high demand. The efficient generation of random realistic human heads is motivated by the need for a substantial number of background and non-player characters without hand-authoring them. Examples include random encounters in role-playing games, characters of a background crowd in cinematics, a virtual audience of stadiums, secondary team players in sports games, and a virtual audience in the virtual reality (VR) events like classes, concerts, and alike. Randomly generated player avatars also fall into the category of pseudo-random characters. All these have to come in large numbers at a low production cost, perhaps, even on-the-fly during run-time. A potential shortcut is to use random photographs of real people and reproduce their likeness via reconstruction and 3D shape estimation. While face generation from real references could technically work for randomization, it can be problematic due to privacy and licensing concerns around facial datasets.

### SUMMARY OF CERTAIN EMBODIMENTS

In some aspects, the techniques described herein relate to a computer-implemented method including: receiving a request to generate a first virtual face model; accessing an identity engine trained based on a plurality of human faces, each human face being defined based on location information associated with a plurality of facial features, wherein the identity engine trained to generate a latent feature representation of individual human faces, wherein the latent feature representation is associated with an identity of the virtual human face; generating, using the identity engine, a latent feature representation of the first virtual face based at least in part on the request, wherein the latent feature representation is associated with a first identity; accessing a decoding engine, the decoding engine trained to reconstruct, via a latent variable space, authoring parameters for an authoring engine based on a latent feature representation of a human face; generating, using the decoding engine, authoring parameters based at least in part on the latent feature representation of the first virtual face; and generating, using the authoring engine, a virtual face model of the at least one virtual face based at least in part on the authoring parameters, wherein the virtual face model has the first identity, wherein the virtual face model is mesh model.

In some aspects, the techniques described herein relate to a computer-implemented method, wherein the request further includes an image of a human face, and wherein the image of the human has the first identity.

In some aspects, the techniques described herein relate to a computer-implemented method, wherein the latent feature representation is pseudo-randomly generated based on a latent space associated with the identity engine.

In some aspects, the techniques described herein relate to a computer-implemented method, wherein the request further includes requests to generate a plurality of virtual face models and latent feature representation of individual virtual faces is generated for each of the plurality of requested virtual face models.

In some aspects, the techniques described herein relate to a computer-implemented method, wherein each of the plurality of virtual face identities is pseudo-randomly generated and each of the virtual face identities is generated from the latent space associated with the identity engine, wherein each latent feature representation is separated from other latent feature representations by a defined threshold value.

In some aspects, the techniques described herein relate to a computer-implemented method further including generating at least one facial characteristic associated with the mesh of the virtual face model.

In some aspects, the techniques described herein relate to a computer-implemented method, wherein the at least one facial characteristic includes at least one of skin texture, eye texture, hair mesh, or hair texture.

In some aspects, the techniques described herein relate to a computer-implemented method, wherein the decoding engine is trained based on the latent space specific to the identity engine and the authoring parameters specific to the authoring engine.

In some aspects, the techniques described herein relate to a computer-implemented method, wherein the latent feature representation is a vector have defined number of values.

In some aspects, the techniques described herein relate to a computer-implemented method, wherein the vector is representative of an invariant identity of first identity.

In some aspects, the techniques described herein relate to a computer-implemented method, wherein the virtual face model is generated based on weights associated with a plurality of blendshapes that the define a shape of the mesh model.

In some aspects, the techniques described herein relate to a computer-implemented method, wherein the authoring parameters define weights associated with the plurality of blendshapes.

In some aspects, the techniques described herein relate to a computer-implemented method, wherein the decoding engine is a machine learning generated using a deep neural network.

In some aspects, the techniques described herein relate to non-transitory computer storage media storing instructions that when executed by a system of one or more computers, cause the one or more computers to perform operations including: receiving a request to generate a first virtual face model; accessing an identity engine trained based on a plurality of human faces, each human face being defined based on location information associated with a plurality of facial features, wherein the identity engine trained to generate a latent feature representation of individual human faces, wherein the latent feature representation is associated with an identity of the virtual human face; generating, using the identity engine, a latent feature representation of the first virtual face based at least in part on the request, wherein the latent feature representation is associated with a first identity; accessing a decoding engine, the decoding engine trained to reconstruct, via a latent variable space, authoring parameters for an authoring engine based on a latent feature representation of a human face; generating, using the decoding engine, authoring parameters based at least in part on the latent feature representation of the first virtual face; and generating, using the authoring engine, a virtual face model of the at least one virtual face based at least in part on the authoring parameters, wherein the virtual face model has the first identity, wherein the virtual face model is mesh model.

In some aspects, the techniques described herein relate to a non-transitory computer storage media, wherein the latent feature representation is pseudo-randomly generated based on a latent space associated with the identity engine.

In some aspects, the techniques described herein relate to a non-transitory computer storage media, wherein the request further includes requests to generate a plurality of virtual face models and latent feature representation of individual virtual faces is generated for each of the plurality of requested virtual face models.

In some aspects, the techniques described herein relate to a non-transitory computer storage media, wherein each of the plurality of virtual face identities is pseudo-randomly generated and each of the virtual face identities is generated from the latent space associated with the identity engine, wherein each latent feature representation is separated from other latent feature representations by a defined threshold value.

In some aspects, the techniques described herein relate to a system including one or more computers and non-transitory computer storage media storing instructions that when executed by the one or more computers, cause the one or more computers to perform operations including: receiving a request to generate a first virtual face model; accessing an identity engine trained based on a plurality of human faces, each human face being defined based on location information associated with a plurality of facial features, wherein the identity engine trained to generate a latent feature representation of individual human faces, wherein the latent feature representation is associated with an identity of the virtual human face; generating, using the identity engine, a latent feature representation of the first virtual face based at least in part on the request, wherein the latent feature representation is associated with a first identity; accessing a decoding engine, the decoding engine trained to reconstruct, via a latent variable space, authoring parameters for an authoring engine based on a latent feature representation of a human face; generating, using the decoding engine, authoring parameters based at least in part on the latent feature representation of the first virtual face; and generating, using the authoring engine, a virtual face model of the at least one virtual face based at least in part on the authoring parameters, wherein the virtual face model has the first identity, wherein the virtual face model is mesh model.

In some aspects, the techniques described herein relate to a system, wherein the request further includes requests to generate a plurality of virtual face models and latent feature representation of individual virtual faces is generated for each of the plurality of requested virtual face models.

In some aspects, the techniques described herein relate to a system, wherein each of the plurality of virtual face identities is pseudo-randomly generated and each of the virtual face identities is generated from the latent space associated with the identity engine, wherein each latent feature representation is separated from other latent feature representations by a defined threshold value.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIG. 1A illustrates a block diagram of a computing environment for implementing a face generation system.

FIG. 1B illustrates an example of a process of training aspects of the face generation system.

FIG. 1C illustrates an example embodiment of aspects of an identity engine.

FIG. 2 illustrates a block diagram of a runtime process of a face generation system.

FIG. 3 illustrates an embodiment of a flowchart of an example process for generating a decoding engine for mapping a latent feature space to authoring parameters of an authoring engine.

FIG. 4 illustrates an embodiment of a flowchart of an example process for generating face models based on latent feature representations of identities.

FIG. 5A illustrates examples of face shapes generated by an authoring engine.

FIG. 5B illustrates examples of face shapes generated by an authoring engine using the face generation system.

FIG. 6 illustrates an embodiment of computing device according to the present disclosure.

Like reference numbers and designations in the various drawings indicate like elements.

### DETAILED DESCRIPTION

### Overview

This specification describes, among other things, technical improvements with respect to generation of face models for virtual characters configured for use in electronic video games. As will be described a system described herein (e.g., the face generation system) may generate realistic face models, including meshes and textures, based on latent space representations of an identity engine. Advantageously, the system may allow for substantially automated face model generation. While electronic games are described, it may be appreciated that the techniques described herein may be applied generally to generation of face models and features of character models. For example, animated content (e.g., TV shows, movies) may employ the techniques described herein.

The face generation system can utilize machine learning models to generate a face models using a face model authoring system based on identity information generated by an identity encoding system. The face models may be generated based on a request providing identity information to the identity encoding system or requesting that the identity encoding system automatically generate identity information. The output of which can be provided to an authoring system to output a face model.

The system may use machine learning techniques, such as an autoencoder, to reduce a dimensionality associated with the input features. In some embodiments, principle component analysis may be used as a dimensionality reduction technique. With respect to an autoencoder, the system may learn a latent feature space of a lower-dimension than the input features. With respect to an autoencoder, an encoder may learn to map input features of expressions to the latent feature space. A decoder may then learn to map the latent feature space to an output defining features of the face models. Thus, the autoencoder may be trained to generate an output face model based on a latent feature representation. The learned latent feature space may represent a bottleneck, which causes each latent variable in the latent feature space to encode complex information associated with face models. In this way, the autoencoder may learn a latent feature space representing realistic face models.

The training process for generating a decoder engine for an authoring engine can include generating synthetic training data by the authoring engine. The synthetic training data can be face models generated by the authoring engine. The training of the decoder engine can generate a mapping of a latent representation to another linear model, such as the authoring parameters of a linear modeling space for a blendshape-based model, to generate face shapes consistent with the domain used for training the autoencoder. The trained decoder engine can generate authoring parameters corresponding to the identities generated within the latent space of the identity engine. These authoring parameters can then be used by the authoring engine to automatically generate synthetic face shapes that are representative of realistic human faces.

In some embodiments, the techniques described herein can be used during the development process of the electronic game. In some embodiments, the techniques described herein may be performed during in-game gameplay of an electronic game. For example, the game may need to populate a location within the game environment, such as a stadium, with thousands of realistic face models. The electronic game may automatically generate realistic and distinct face models for the identified game environment.

In some embodiments, the user may provide an image of a face to be used for an in-game character to be used within the electronic game. For example, the face generation system can generate a face model that is a realistic representation of the user for use as an in-game character within the electronic game.

### Example Networked Computing Environment

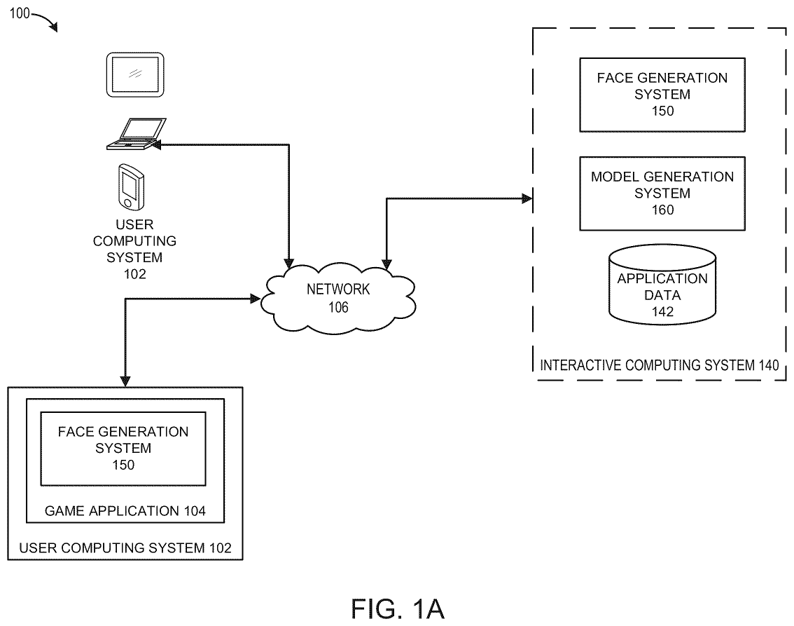

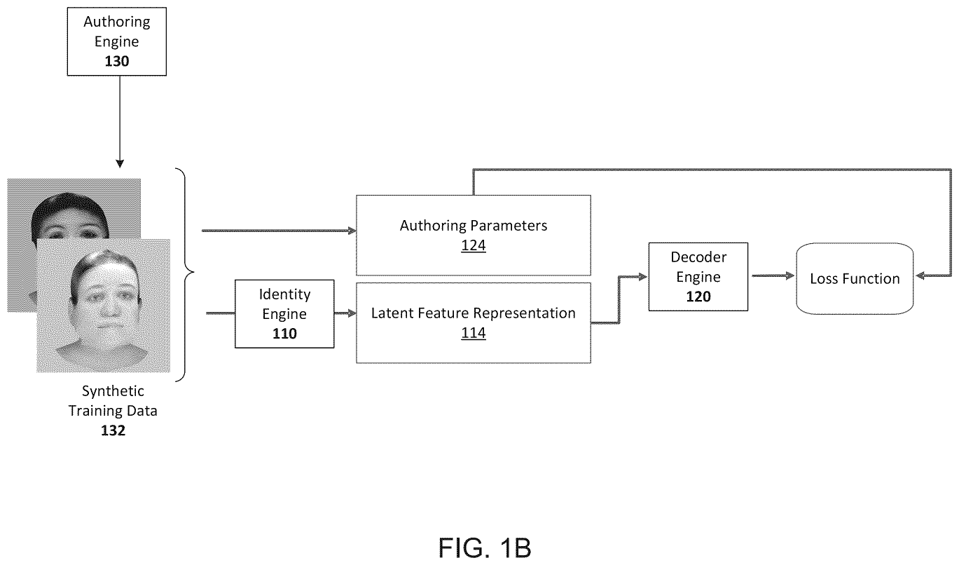

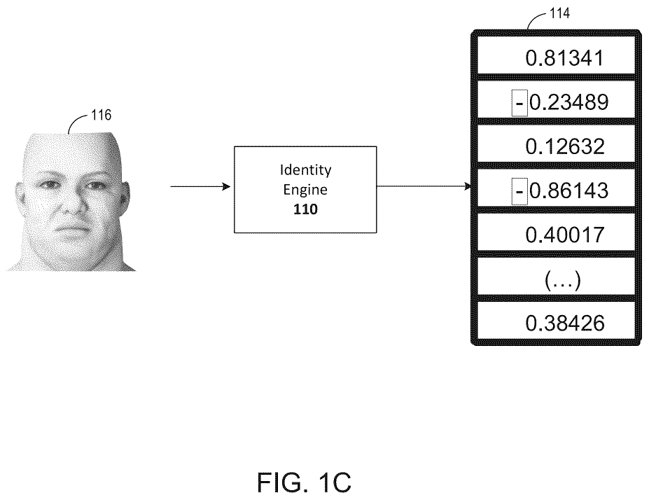

FIG. 1A illustrates an embodiment of a computing environment 100 for implementing a face generation system 150. The environment 100 includes a network 106, a plurality of user computing systems 102 and an interactive computing system 140, which includes face generation system 150, model generation system 160, and application data store 142. The user computing system(s) 102 may communicate via a network 106 with the interactive computing system 140.

Although only one network 106 is illustrated, multiple distinct and/or distributed networks 106 may exist. The network 106 can include any type of communication network. For example, the network 106 can include one or more of a wide area network (WAN), a local area network (LAN), a cellular network, an ad hoc network, a satellite network, a wired network, a wireless network, and so forth. In some embodiments, the network 106 can include the Internet.

### User Computing System

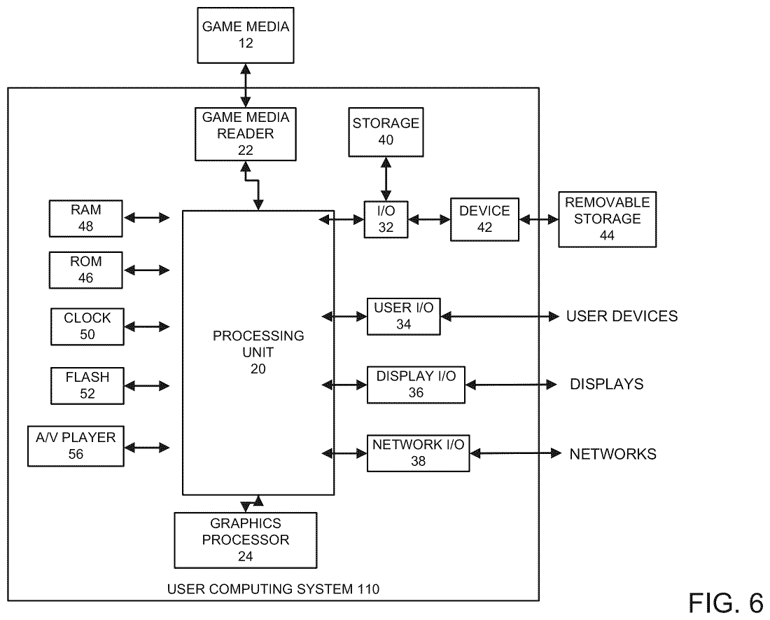

The user computing system 102 includes computing resources and an application data store 106. The user computing system 102 may have varied local computing resources such as central processing units and architectures, memory, mass storage, graphics processing units, communication network availability and bandwidth, and so forth. Further, the user computing system 102 may include any type of computing system. For example, the user computing system 102 may be any type of computing device, such as a desktop, laptop, video game platform/console, television set-top box, television (for example, Internet TVs), network-enabled kiosk, car-console device, computerized appliance, wearable device (for example, smart watches and glasses with computing functionality), and wireless mobile devices (for example, smart phones, PDAs, tablets, or the like), to name a few. A more detailed description of an embodiment of a computing system 102 is described below with respect to FIG. 6.

### Game Application

The user computing system 102 can execute a game application based on software code stored at least in part in the application data store. The game application may also be referred to as a videogame, a game, game code and/or a game program. A game application should be understood to include software code that a computing device 102 can use to provide a game for a user to play. A game application may comprise software code that informs a computing device 102 of processor instructions to execute but may also include data used in the playing of the game, such as data relating to constants, images, route information, and other data structures. In the illustrated embodiment, the game application includes a game engine, game data, and game state information.

In some embodiments, the user computing system 102 is capable of executing a game application, which may be stored and/or executed in a distributed environment. For example, the user computing system 102 may execute a portion of a game and a network-based computing system, may execute another portion of the game. For example, the game may be an online multiplayer game that includes a client portion executed by the user computing system 102 and a server portion executed by the interactive computing system 140.

The game engine can be configured to execute aspects of the operation of the game application within the user computing system 102. Execution of aspects of gameplay within a game application can be based, at least in part, on the user input received, the game data, and game state information. The game data can include game rules, animation data, environmental settings, constraints, skeleton models, route information, and/or other game application information.

The game engine can execute gameplay within the game according to the game rules. Examples of game rules can include rules for scoring, possible inputs, actions/events, movement in response to inputs, and the like. Other components can control what inputs are accepted and how the game progresses, and other aspects of gameplay. The game engine can receive the user inputs and determine in-game events, such as actions, jumps, runs, throws, attacks and other events appropriate for the game application. During runtime operation, the game engine can read in game data and game state information to determine the appropriate in-game events. The game engine can include controllers for virtual objects within the game application that can control actions performed by the virtual object during runtime of the game application.

In one example, after the game engine determines the character events, the character events can be conveyed to a character controller that can determine the action state of the character and appropriate motions the character should make in response to the events. The physics engine can determine new poses for the characters based on the action state and provide the new poses to a skinning and rendering engine. The skinning and rendering engine, in turn, can provide character images to an object combiner in order to combine animate, inanimate, and background objects into a full scene. The full scene can be conveyed to a renderer, which generates a new frame for display to the user. The process can be repeated for rendering each frame during execution of the game application. Though the process has been described in the context of a character, the process can be applied to any process for processing events and rendering the output for display to a user.

The game data can include game rules, prerecorded motion capture poses/paths, environmental settings, environmental objects, constraints, skeleton models, route information, and/or other game application information. At least a portion of the game data can be stored in the application data store 106. In some embodiments, a portion of the game data may be received and/or stored remotely, such as in the source asset data store. In such embodiments, game data may be received during runtime of the game application.

During runtime, the game application can store game state information, which can include a game state, character states, environment states, scene object storage, route information and/or other information associated with a runtime state of the game application. For example, the game state information can identify the state of the game application at a specific point in time, such as a character position, character orientation, character action, game level attributes, and other information contributing to a state of the game application. The game state information can include dynamic state information that continually changes, such as character movement positions, and static state information, such as positions of goal posts on a field.

### Interactive Computing System

The interactive computing system 140 may include application host systems and an application data store 142. In some embodiments, the interactive computing system 140 can include one or more computing devices, such as servers and databases that may host and/or execute a portion of one or more instances of the game application. In some embodiments, the application host systems can include one or more computing devices, such as servers and databases that may host and/or execute a portion of one or more instances of the game application. In certain embodiments, instead of or in addition to executing a portion of the game application, the application host systems may execute another application, which may complement and/or interact with the game application during execution of an instance of the game application.

The interactive computing system 140 may enable multiple users or computing systems to access a portion of the game application executed or hosted by the interactive computing system 140. The interactive computing system 140 can have one or more game servers that are configured to host online video games. For example, the interactive computing system 140 may have one or more game servers that are configured to host an instanced (e.g., a first person shooter multiplayer match) or a persistent virtual environment (e.g., a multiplayer online roll playing game). The virtual environment may enable one or more users to interact with the environment and with each other in a synchronous and/or asynchronous manner. In some cases, multiple instances of the persistent virtual environment may be created or hosted by one or more game servers. A set of users may be assigned to or may access one instance of the virtual environment while another set of users may be assigned to or may access another instance of the virtual environment. In some embodiments, the interactive computing system 140 may execute a hosting system for executing various aspects of a game environment. For example, in one embodiment, the game application may be a competitive game, such as a first person shooter or sports game, and the interactive computing system 140 can provide a dedicated hosting service (such as, through the game servers) for hosting multiplayer game instances or facilitate the creation of game instances hosted by user computing systems 102.

### Face Generation System

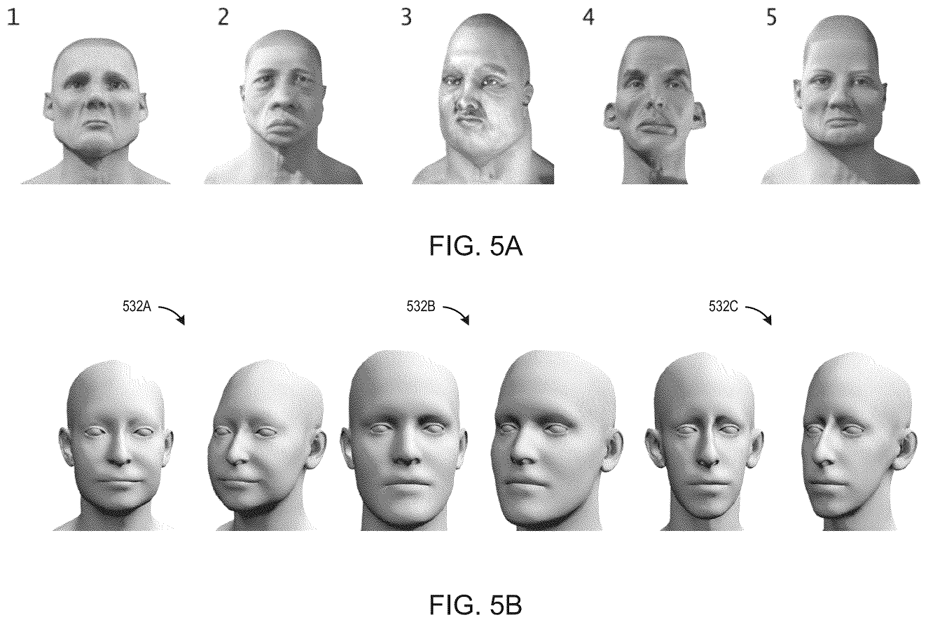

The face generation system 150 can utilize machine learning models to generate a face models (such as illustrated in FIG. 5B) using a face model authoring system, such as authoring engine 130, based on identity information generated by an identity encoding system, such as identity engine 110. The face generation system 150 may, in some embodiments, be a system of one or more computers, one or more virtual machines executing on a system of one or more computers, and so on. In some embodiments, the face generation system 150 may be implemented as a module, or software (e.g., an application), which may execute on a user device (e.g., a laptop, tablet, console gaming system, and so on). The models 532A-532C illustrated in FIG. 5B are an example output of face models being generated by the face generation system 150. While three distinct models are illustrated, it may be appreciated that any number of face models may be generated by the face generation system 150. The face models may be generated based on a request providing identity information to the identity encoding system or requesting that the identity encoding system automatically generate identity information. The output of which can be provided to an authoring system to output a face model. In some embodiments, the face generation system 150 may be executed by the user computing system 102 and/or the interactive computing system 140 during runtime of the game application 104 to generate face models for one or more virtual characters within a virtual environment. The details of operation and training of the face generation system 150 will be further described herein.

### Model Generation System

The model generation system 160 can use one or more machine learning algorithms to generate one or more generative models or parameter functions. One or more of these prediction models may be used to determine an expected value or occurrence based on a set of inputs. The machine learning algorithms can be configured to adaptively develop and update the models over time based on new input received by the model generation system 160. For example, the models can be regenerated on a periodic basis as new information is available to help keep the models accurate over time. The model generation system 160 is described in more detail herein.

### Application Data Store

The interactive computing system 140 can include one or more application data stores 142 that are configured to store information associated with one or more game applications, the face generation system 150, and/or the model generation system 160. For example, the application data stores 142 can store model data generated by the model generation system. The interactive computing system 140 can include one or more data stores 142 that are configured to store information associated with game application hosted by the interactive computing system 140. The application data stores 142 can include information associated with the game application that is generated by the face generation system 150. For example, the game data stores 142 can include face shapes generated by the face generation system 150 that are used during runtime of the game application.

### Embodiments of Model Training for the Face Generation System

FIG. 1B illustrates an example of a process of training aspects of the face generation system 150. In this example, the face generation system 150 may implemented as an autoencoder. As illustrated, the autoencoder may include the identity engine 110 that generates identity information, such as a latent feature representation 114. The decoder engine 120 is trained to generate authoring parameters 124 based on the latent feature representation 114. The components and training of the face generation system 150 are further described below.

### Authoring Engine

The authoring engine 130 can be configured to generate face models based one a plurality of authoring parameters 124. The face models can be parametric face models. The parametric facial modeling system captures the face shape via weights applied to the blendshapes or bone deformations used for modeling the geometry of the head. Design of blendshapes can rely on anatomical knowledge, manually modeled heads, scans, 4D animation capture, or a combination of these. The goal of a parametric face model is to provide a sufficiently wide expressive range to represent a large variety of heads.

Due to the range of expressive power and independence of parameters, a parametric model may produce unrealistic grotesque or cartoonish heads when used with extreme values of the parameters. Characters generated with extreme parameter values may also look technically broken when the underlying mesh self-penetrates, folds on itself or creates unnatural cusps, such as illustrated by the face shapes 1-5 in FIG. 5A. However, artificially limiting the values may lead to a repetitive synthetic appearance breaking the fiction of the virtual world.

The parametric representation of 3D shape assumes the presence of the proper construction basis. In some embodiments, a blendshape model can be used. A blendshape model generates a facial pose as a linear combination of a number of facial expressions. By varying the weights of the linear combination, a range of facial expressions can be expressed with little computation. The set of shapes can be extended as desired to refine the range of expressions that the character can produce. Blendshapes provide linear face models in which the individual basis vectors are not orthogonal but instead represent individual facial expressions. The individual basis vectors can be referred to blendshapes and the corresponding weights can be referred to as sliders. The blendshapes are versatile and can describe static neutral shapes and animations like dynamic facial expressions. The implementation details may vary widely utilizing explicit mesh morphs, bone deltas, magnets, etc. A feature of the blendshape model is its linearity: the space of general deformations is decomposed via the vectors in multidimensional space to represent a particular target shape. The weights of the blendshapes contributing to the target shape (as in decomposing a vector into a basis) can accurately define the geometry within a specific domain.

The linearity of the parametric model can help to generate plausible, realistic parametric heads. Another important feature is the basis vector's explicit visual or anatomical semantics. The engineered semantics can be local and not have implicit knowledge related to the correlation of the features. The authoring parameters 124 generated by the decoder engine 120 can identity the blendshape weights that can be used by the authoring engine 130 to generate a face model 132. The face model can be a mesh defining the shape of the face based on the weights of the blendshapes.

The authoring engine 130 can additionally be configured to generate other facial characteristics, such as skin textures, eye textures, hair style, facial effects (e.g., car rings, scars, freckles, etc.) that are used to complete a facial model.

### Identity Engine

The identity engine 110 can be described with further reference to FIG. 1C. The identity engine 110 can use machine learning techniques to provide a facial recognition system to generate identity information, which can be expressed as vector 114. The vector represents a latent feature representation 114 of the identity information based on an input face 116 of a person. The identity engine 110 can be based on facial recognitions systems, such as FaceNet. The identity engine can generate a high-quality face mapping from the images using deep learning architectures such as ZF-Net and Inception. Then it can use a method called triplet loss as a loss function to train this architecture.

One embodiment of a process for generating a latent feature representation 114 can include a finding the bounding box of the location of faces. Then finding facial features such as length of eyes, length of mouth, the distance between eyes and nose, and so on. The number of facial features chosen may vary, for example, from five to seventy-eight points, depending on annotation. After identifying facial features, the distance between these points is measured. These values are used to classify a face. The faces can be aligned using the facial features. This can be done to align face images displayed from a different angle in a straightforward orientation. Then the features extracted can be matched with a template. The aligned faces can be used for comparison. The aligned face can then be analyzed to generate an embedding of the face using face clustering. The resultant identification encoding of the face, also referred to as an identification representation, can be output for further use be the face generation system 150. Though not perfect, the identification representation can be invariant to occlusion, pose, lighting and even age, and other factors that would affect perceptive differences between different images of the same person. The latent feature representation 114 is representative of an encoding that provides an identity of a person, which can also be referred to as the identity or identity information of a person. In some embodiments, the latent feature representation 114 can be a 512 value encoding.

### Decoder Engine

An autoencoder machine learning model may be used for generating a decoder engine 120. As may be appreciated, an autoencoder can be generated using a supervised machine learning technique capable of learning efficient representations of input data. The decoder engine 120 may represent neural networks, such as dense (e.g., fully connected) neural networks. As described above, the output of the identity engine 110 may be provided to the decoder engine 120 through a shared layer of variables (e.g., hidden variables) which may be referred to as the latent feature representation 114 of the input. As may be appreciated, the output of the identity engine 110 may be obtained via a forward pass of input identity information through layers forming the identity engine 110.

The face generation system 150 may use a trained encoder, such as the identity engine 110 that encodes the identity information into a latent feature representation 114. The encoder may be a universal encoder for translating the input images and video into latent feature space representations. A resulting latent feature representation may be generated which is based on distributions of latent variables. The identity engine 110 can be trained prior to training of the decoder engine 120. The face generation system 150 can train a decoder engine for each authoring engine 130. Each trained decoder engine 120 can then be used to decode a latent feature representation 114 in order to output a face model associated with the identity represented by the latent feature representation 114.

The training process for generating a decoder engine 120 for an authoring engine 130 includes generating synthetic training data 132 by the authoring engine 130. The synthetic training data 132 can be a face model generated by the authoring engine 130. The application host systems 132 can include at least two components, 1) the face model includes the authoring parameters 124 associated with the generated face model, and 2) an image of the generated face model. The image of the face model is provided to the identity engine 110 to generate a latent feature representation 114 of the face. The goal of training the decoder engine 120 is to generate a face model based on latent feature representation 114 using the authoring parameters 124. The training of the decoder engine 120 generates a mapping of a latent representation (e.g., latent feature representation 114) to another linear model (e.g., the authoring parameters 124 of a linear modeling space for a blendshape-based model) to generate shapes consistent with the domain used for training the autoencoder. In one embodiment, a FaceNet embedding and a target blendshape-based model with linear parametric spaces are used.

In some embodiments, to construct the mapping using machine learning (ML) techniques, random parameters can be generated by the authoring engine 130 and the corresponding synthetic images. Next, a latent feature representation 114 is generated by the identity engine 110 for the generated synthetic images. The data pairs (i.e., the authored face models and corresponding latent feature representation 114) comprise the training data for the corresponding supervised ML problem. A Deep Neural Network (DNN) approach can be used to train the ML model. In one example, a dataset includes 150,000 pairs total with 9:1 split between training and validation datasets. Randomization can be utilized to get a uniform distribution of parameters values. Varying the DNN architectures can reach similar optimal performance across a wide range of possible architectures. In one embodiment, a single fully-connected hidden layer FC(32k) is used to map the latent spaces of interest.

The authoring parameters 124 for the authoring engine 130 are the target output of the decoder engine 120. The decoder engine 120 can be trained for a specific identity engine 110 and a specific authoring engine 130. Advantageously, once a decoder engine 120 is generated, new face models can be generated by the authoring engine 130 by providing latent feature representations 114 generated by the identity engine 110 to the decoder engine 120. For example, the latent feature representation may be generated randomly or pseudo-randomly by the identity engine 110. Once generated, the decoder engine 120 can generate authoring parameters 124 corresponding to the generated identities. These authoring parameters 124 can then be used by the authoring engine 130 to automatically generate synthetic face shapes that are representative of human faces. In this way, the face generation system 150 may generate new face models based on randomly generated identities from an identity engine 110. These expressions may advantageously represent realistic face shapes of people (such as illustrated in FIG. 5B).

### Example Block Diagrams—Generating Output of Face Model(s)

Generating realistic face shapes for a person for use within an electronic game is of great importance to electronic game designers. For example, generating realistic face shapes for a large group of virtual characters within a game environment, such as in a stadium or on within a city can allow for game designers to generate realistic virtual environments where non-player characters have varying features. As will be described, the techniques described herein may allow for rapid generation of realistic face shapes of that generally match the face shapes of real-life persons. For example, thousands of face shapes of persons within a crowd may be randomly generated by the face generation system 150.

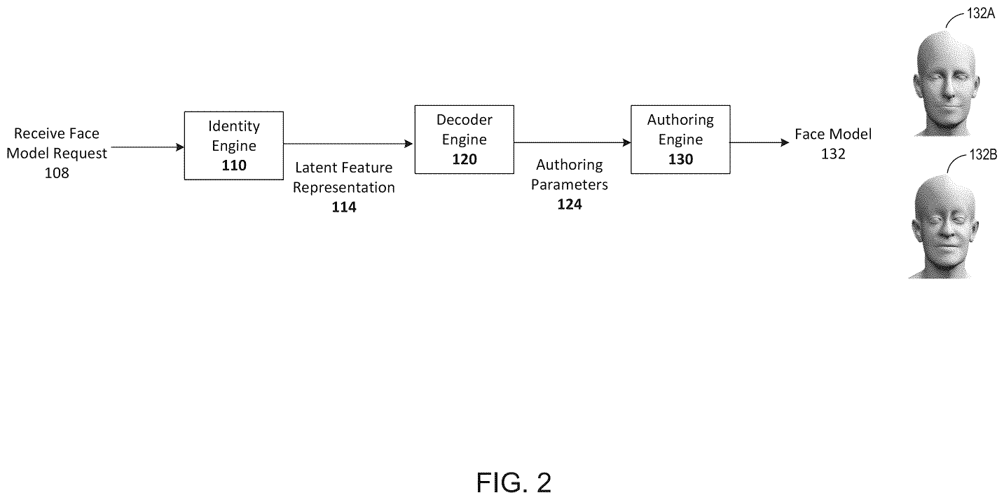

FIG. 2 illustrates a block diagram of components of the face generation system 150. The components can include identity engine 110, decoder engine 120, and authoring engine 130. The identity engine 110 and decoder engine 120 are previously trained models. The identity engine 110 can generate a latent feature representation 114 representing a facial identity and the decoder engine 120 can generate authoring parameters 124 based on the latent feature representation 114. The authoring parameters 124 are specific to the authoring engine 130 and map to blendshapes used for generating face shapes within the authoring engine 130.

The face generation system 150 can receive a request 108 to generate one or more face models. The request 108 can be generated prior to operation of a game application (e.g., game application 104) in order to create face models that are to be pre-loaded into the game application. In such instances, the face generation system 150 may be executed during game development. In some embodiments, the face generation system 150 request may be configured to receive requests during runtime of the game application 104. The request can specify a number of face models to generate. For example, the request may be a request for face models to populate a stadium (e.g., thousands), a city street (e.g., hundreds), or other type of in-game event or location. In some embodiments, the request may include images associated with real-life persons that are to be generated. For example, a user may upload an image and request that a virtual entity is created based on the image.

The identity engine 110 can receive the request and generate a latent feature representation 114 corresponding to each entity requested. The latent feature representation 114 can be pseudo-randomly generated. The pseudo-random generation can be performed in order to select representations within the latent space that represent visually distinct faces. If values are selected within the latent space that are too close, the faces will not be substantially distinguishable. The pseudo-random generation of the latent feature representation 114 can be configured to select the values that are different from each other by a defined threshold or magnitude. The latent feature representations 114 are provided to the decoder engine 120, which can generate authoring parameters 124 for each of the latent feature representations 114. The authoring engine 130 can generate the face models 132 based on the authoring parameters 124. Additionally, the authoring engine 130 can generate other facial characteristics, such as skin textures, eye textures, hair style, facial effects (e.g., car rings, scars, freckles, etc.) that are used to complete a facial model. In this manner, realistic and distinct face models can be automatically generated for use within a game application.

### Example Flowcharts for Training and Generation by Face Generation System

Generating realistic face models for a person for use within an electronic game is of great importance to electronic game designers. For example, generating realistic face models may allow for game designers to populate areas within a game application with distinct facial models for the virtual entities rather than reusing a defined set of face models. As will be described, the techniques described herein may allow for training of a model to be used for rapid generation of face models of realistic human faces based on synthetic training data.

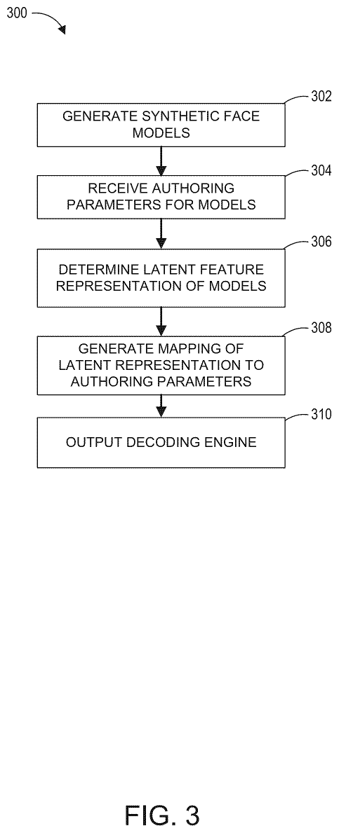

FIG. 3 is a flowchart of an example process 300 for generating a decoding engine for mapping a latent feature space to authoring parameters of an authoring engine. The process 300 can be implemented by any system that can process data of the authoring engine 130. For example, the process 300, in whole or in part, can be implemented by a game application 104, an interactive computing system 140, face generation system 150, model generation system 160 and/or another system. Although any number of systems, in whole or in part, can implement the process 300, to simplify discussion, the process 300 will be described with respect to particular systems. Further, although embodiments of the process 300 may be performed with respect to variations of systems comprising various game application environments, to simplify discussion, the process 300 will be described with respect to the interactive computing system 140.

At block 302, the system generates synthetic face models of virtual entities. The synthetic training can be generated by an authoring engine. The synthetic training data 132 can be a face model generated by the authoring engine 130. The system can use random parameters generated by the authoring engine 130 and generate corresponding synthetic face models.

At block 304, the system receives authoring parameters for face models. The synthetic training data generated by the authoring engine can include authoring parameters used for generating the face models. The authoring parameters correspond to the parameters used by a parametric facial modeling system to generate the face models.

At block 306, the system determines the latent feature representation of the face models. The latent feature representation 114 can be generated by the identity engine 110 for each of the generated synthetic images. The identity engine may be a universal encoder for translating the input images and video into latent feature space representations. A resulting latent feature representation may be generated which is based on distributions of latent variables. The identity engine can be a pretrained encoder, such as FaceNet, configured to generate a latent feature representation of a defined length, such as a 512 value encoding.

At block 308, the system generates a mapping of the latent feature representation to the authoring parameters. The goal of training the decoder engine 120 is to generate a face model based on latent feature representation 114 using the authoring parameters 124. The training of the decoder engine 120 generates a mapping of a latent representation (e.g., latent feature representation 114) to another linear model (e.g., the authoring parameters 124 of a linear modeling space for a blendshape-based model) to generate shapes consistent with the domain used for training the autoencoder. To construct the mapping using ML techniques, random parameters can be generated by the authoring engine 130 and the corresponding synthetic images. Next, a latent feature representation 114 is generated by the identity engine 110 for the generated synthetic images. The data pairs (i.e., the authored face models and corresponding latent feature representation 114) comprise the training data for the corresponding supervised ML problem. A Deep Neural Network (DNN) approach can be used to train the ML model.

At block 310, the system outputs a decoder engine. The decoder engine is configured to generate authoring parameters 124 for the authoring engine 130 based on latent feature representations. The decoder engine 120 can be trained for a specific identity engine 110 and a specific authoring engine 130. Advantageously, once a decoder engine 120 is generated, new face models can be generated by the authoring engine 130 by providing latent feature representations 114 generated by the identity engine 110 to the decoder engine 120.

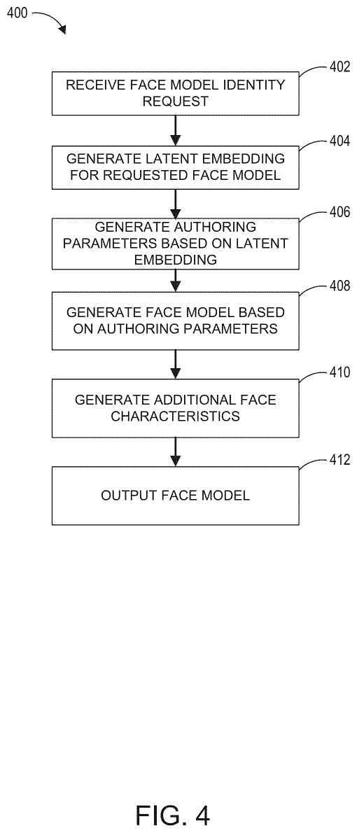

FIG. 4 is a flowchart of an example process 400 for generating face models based on latent feature representations of identities. The process 400 can be implemented by any system that can process data and generate face models. For example, the process 400, in whole or in part, can be implemented by a game application 104, an interactive computing system 140, face generation system 150 and/or another system. Although any number of systems, in whole or in part, can implement the process 400, to simplify discussion, the process 400 will be described with respect to particular systems. Further, although embodiments of the process 400 may be performed with respect to variations of systems comprising various game application environments, to simplify discussion, the process 400 will be described with respect to the interactive computing system 140.

At block 402, the system receive a request 108 to generate identities for one or more face models. The request 108 can be generated prior to operation of a game application (e.g., game application 104) in order to create face models that are to be pre-loaded into the game application. In such instances, the face generation system 150 may be executed during game development. In some embodiments, the face generation system 150 request may be configured to receive requests during runtime of the game application 104. The request can specify a number of face identities/models to generate. For example, the request may be a request for face models to populate a stadium (e.g., thousands), a city street (e.g., hundreds), or other type of in-game event or location.

At block 404, the system generates a latent feature representation for each requested face model. The latent feature representation 114 can be pseudo-randomly generated. The pseudo-random generation can be performed in order to select representations within the latent space that represent visually distinct faces. If values are selected within the latent space that are too close, the faces will not be substantially distinguishable. The pseudo-random generation of the latent feature representation 114 can be configured to select the values that are different from each other by a defined threshold or magnitude.

At block 406, the system generates authoring parameters for each of the latent feature representations. The authoring parameters that are generated can be used by a parametric facial modeling system. A parametric facial modeling system can capture a face shape via weights applied to the blendshapes to generate a face model. In some embodiments, the authoring parameters 124 can identity blendshape weights that can be used by an authoring engine 130 to generate a face model 132.

At block 408, the system generates a face model based on the authoring parameters. An authoring engine can generate a face model based on the authoring parameters. The authoring engine can generate a mesh having a face shape defined by the weights of each of the blendshapes of the parametric facial model.

At block 410, the system generates additional face characteristics. The system can additionally be configured to generate other facial characteristics, such as skin textures, eye textures, hair style, facial effects (e.g., ear rings, scars, freckles, etc.) that are used to complete a facial model.

At block 412, the system outputs a face model for each of the latent feature representations. The output of the face model can include the mesh, textures, and data associated with generation of the face model by the authoring engine.

### Computing System

FIG. 6 illustrates an embodiment of computing device 10 according to the present disclosure. Other variations of the computing device 10 may be substituted for the examples explicitly presented herein, such as removing or adding components to the computing device 10. The computing device 10 may include a game device, a smart phone, a tablet, a personal computer, a laptop, a smart television, a car console display, a server, and the like. As shown, the computing device 10 includes a processing unit 20 that interacts with other components of the computing device 10 and also external components to computing device 10. A media reader 22 is included that communicates with media 12. The media reader 22 may be an optical disc reader capable of reading optical discs, such as CD-ROM or DVDs, or any other type of reader that can receive and read data from game media 12. One or more of the computing devices may be used to implement one or more of the systems disclosed herein.

Computing device 10 may include a separate graphics processor 24. In some cases, the graphics processor 24 may be built into the processing unit 20. In some such cases, the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a handheld video game device, a dedicated game console computing system, a general-purpose laptop or desktop computer, a smart phone, a tablet, a car console, or other suitable system.

Computing device 10 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 10. Processing unit 20 can communicate through I/O 32 to store data, such as game state data and any shared data files. In addition to storage 40 and removable storage media 44, computing device 10 is also shown including range of motion (Read-Only Memory) 46 and RAM 48. RAM 48 may be used for data that is accessed frequently.

User I/O 34 is used to send and receive commands between processing unit 20 and user devices, such as game controllers. In some embodiments, the user I/O can include a touchscreen inputs. The touchscreen can be capacitive touchscreen, a resistive touchscreen, or other type of touchscreen technology that is configured to receive user input through tactile inputs from the user. Display I/O 36 provides input/output functions that are used to display images from the game being played. Network I/O 38 is used for input/output functions for a network. Network I/O 38 may be used during execution of a game.

Display output signals produced by display I/O 36 comprising signals for displaying visual content produced by computing device 10 on a display device, such as graphics, user interfaces, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such a display 16.

The computing device 10 can also include other features that may be used with a game, such as a clock 50, flash memory 52, and other components. An audio/video player 56 might also be used to play a video sequence, such as a movie. It should be understood that other components may be provided in computing device 10 and that a person skilled in the art will appreciate other variations of computing device 10.

Program code can be stored in range of motion 46, RAM 48 or storage 40 (which might comprise hard disk, other magnetic storage, optical storage, other non-volatile storage or a combination or variation of these). Part of the program code can be stored in range of motion that is programmable (ROM, PROM, EPROM, EEPROM, and so forth), part of the program code can be stored in storage 40, and/or on removable media such as game media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other game and processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from game media 12 and stored in a memory device, such as RAM 48. Additionally, data from storage 40, range of motion 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

The following list has example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method comprising:
receiving a request to generate a first virtual face model;
accessing an identity engine trained based on a plurality of human faces, each human face being defined based on location information associated with a plurality of facial features, wherein the identity engine trained to generate a latent feature representation of individual human faces, wherein the latent feature representation is associated with an identity of the virtual human face;
generating, using the identity engine, a latent feature representation of the first virtual face based at least in part on the request, wherein the latent feature representation is associated with a first identity;
accessing a decoding engine, the decoding engine trained to reconstruct, via a latent variable space, authoring parameters for an authoring engine based on a latent feature representation of a human face;
generating, using the decoding engine, authoring parameters based at least in part on the latent feature representation of the first virtual face; and
generating, using the authoring engine, a virtual face model of the at least one virtual face based at least in part on the authoring parameters, wherein the virtual face model has the first identity, wherein the virtual face model is mesh model.

2. The computer-implemented method of claim 1, wherein the request further comprises an image of a human face, and wherein the image of the human has the first identity.

3. The computer-implemented method of claim 1, wherein the latent feature representation is pseudo-randomly generated based on a latent space associated with the identity engine.

4. The computer-implemented method of claim 3, wherein the request further comprises requests to generate a plurality of virtual face models and latent feature representation of individual virtual faces is generated for each of the plurality of requested virtual face models.

5. The computer-implemented method of claim 4, wherein each of the plurality of virtual face identities is pseudo-randomly generated and each of the virtual face identities is generated from the latent space associated with the identity engine, wherein each latent feature representation is separated from other latent feature representations by a defined threshold value.

6. The computer-implemented method of claim 1 further comprising generating at least one facial characteristic associated with the mesh of the virtual face model.

7. The computer-implemented method of claim 6, wherein the at least one facial characteristic comprises at least one of skin texture, eye texture, hair mesh, or hair texture.

8. The computer-implemented method of claim 1, wherein the decoding engine is trained based on the latent space specific to the identity engine and the authoring parameters specific to the authoring engine.

9. The computer-implemented method of claim 1, wherein the latent feature representation is a vector have defined number of values.

10. The computer-implemented method of claim 9, wherein the vector is representative of an invariant identity of first identity.

11. The computer-implemented method of claim 1, wherein the virtual face model is generated based on weights associated with a plurality of blendshapes that the define a shape of the mesh model.

12. The computer-implemented method of claim 11, wherein the authoring parameters define weights associated with the plurality of blendshapes.

13. The computer-implemented method of claim 1, wherein the decoding engine is a machine learning generated using a deep neural network.

14. Non-transitory computer storage media storing instructions that when executed by a system of one or more computers, cause the one or more computers to perform operations comprising:
receiving a request to generate a first virtual face model;
accessing an identity engine trained based on a plurality of human faces, each human face being defined based on location information associated with a plurality of facial features, wherein the identity engine trained to generate a latent feature representation of individual human faces, wherein the latent feature representation is associated with an identity of the virtual human face;
generating, using the identity engine, a latent feature representation of the first virtual face based at least in part on the request, wherein the latent feature representation is associated with a first identity;
accessing a decoding engine, the decoding engine trained to reconstruct, via a latent variable space, authoring parameters for an authoring engine based on a latent feature representation of a human face;
generating, using the decoding engine, authoring parameters based at least in part on the latent feature representation of the first virtual face; and
generating, using the authoring engine, a virtual face model of the at least one virtual face based at least in part on the authoring parameters, wherein the virtual face model has the first identity, wherein the virtual face model is mesh model.

15. The non-transitory computer storage media of claim 14, wherein the latent feature representation is pseudo-randomly generated based on a latent space associated with the identity engine.

16. The non-transitory computer storage media of claim 15, wherein the request further comprises requests to generate a plurality of virtual face models and latent feature representation of individual virtual faces is generated for each of the plurality of requested virtual face models.

17. The non-transitory computer storage media of claim 16, wherein each of the plurality of virtual face identities is pseudo-randomly generated and each of the virtual face identities is generated from the latent space associated with the identity engine, wherein each latent feature representation is separated from other latent feature representations by a defined threshold value.

18. A system comprising one or more computers and non-transitory computer storage media storing instructions that when executed by the one or more computers, cause the one or more computers to perform operations comprising:
receiving a request to generate a first virtual face model;
accessing an identity engine trained based on a plurality of human faces, each human face being defined based on location information associated with a plurality of facial features, wherein the identity engine trained to generate a latent feature representation of individual human faces, wherein the latent feature representation is associated with an identity of the virtual human face;
generating, using the identity engine, a latent feature representation of the first virtual face based at least in part on the request, wherein the latent feature representation is associated with a first identity;
accessing a decoding engine, the decoding engine trained to reconstruct, via a latent variable space, authoring parameters for an authoring engine based on a latent feature representation of a human face;
generating, using the decoding engine, authoring parameters based at least in part on the latent feature representation of the first virtual face; and
generating, using the authoring engine, a virtual face model of the at least one virtual face based at least in part on the authoring parameters, wherein the virtual face model has the first identity, wherein the virtual face model is mesh model.

19. The system of claim 18, wherein the request further comprises requests to generate a plurality of virtual face models and latent feature representation of individual virtual faces is generated for each of the plurality of requested virtual face models.

20. The system of claim 19, wherein each of the plurality of virtual face identities is pseudo-randomly generated and each of the virtual face identities is generated from the latent space associated with the identity engine, wherein each latent feature representation is separated from other latent feature representations by a defined threshold value.
